(19) United States
(12) Patent Application Publication
(10) Pub. No.: US 2008/0204401 A1
(43) Pub. Date: Aug. 28, 2008

(54) Control apparatus

(75) Inventors: Ming-Hui Lin, Taipei (TW); Vam Chang, Taipei (TW)

Correspondence Address: BACON & THOMAS, PLLC, 625 SLATERS LANE, FOURTH FLOOR, ALEXANDRIA, VA, 22314, US

(73) Assignee: INVENTEC CORPORATION, Taipei (TW)

(21) Appl. No.: 11/711,801

(22) Filed: Feb. 28, 2007

(51) Int. Cl. G09G 5/00

(52) U.S. Cl. 345/156

(57) ABSTRACT

The present invention is to provide a control apparatus, which includes a casing with two sides each comprising a holding portion extending outwardly and towards a bottom thereof for being held by a user while viewing a front of the casing, the front is inclined progressively from a lateral edge of the front away from the user through the bottom to an opposite lateral edge of the front near the user; a direction input portion disposed on the front of the casing near one of the holding portions; an operation input portion disposed on the front of the casing near the other holding portion; and a sensing input portion disposed on the front of the casing between the direction input portion and the operation input portion and proximate to the user. Thus, a user can press or push any input portion easily for an input while holding the two holding portions by hands.

### FIELD OF THE INVENTION

The present invention relates to a control apparatus, and more particularly to a control apparatus comprising a casing with two sides each having a holding portion extending outwardly and towards a bottom of the casing for being held by a user respectively while playing games, wherein a front of the casing is inclined progressively from a lateral edge of the front away from the user through the bottom of the casing to an opposite lateral edge of the front near the user.

### BACKGROUND OF THE INVENTION

Nowadays, we are entering an information era where the electronic industry is booming. Various high-tech electronic products derived from digital technology are rapidly advancing; various electronic elements and peripheral devices installed on electronic devices are being continuously developed and widely adopted by a variety of industries for use in the living and working environments, which have been a great breakthrough in the human technology development. This developmental trend not only accelerates the efficiency and speed of information circulation, but also benefited the people in terms of their lives and entertainment. However, along with the continuous researches and progresses of current electronic technologies, whether the electronic products can meet the demand of convenience and comfortability in use from users is becoming a great concern of the users.

In contemporary society, entertainment has been indispensable in people's lives. In particular, many young people are fascinated by the game world at the moment. This is because the visual design of current game software employs a large amount of special effects that build special scenes and images by using 2D images to current 3D images, which meets the fans' requirement of a virtual world. In addition, in regard to hardware, game console performance has been greatly improved, and the game console type has also been greatly developed, including arcade game machines placed in public areas, family game consoles (e.g. Nintendo, PlayStation 2), handheld game machines, thus providing the consumers with a diversity of choices. Therefore, the consumers often spend long periods of time on playing the game. Accordingly, to meet the consumers' needs, game providers continuously bring various game software and game consoles to gain more consumers' attention.

However, while the performance and types of the game machine has been greatly developed, the convenience in control operation and comfortability in use of the game machines have not been correspondingly improved. Referring to FIG. 1, which illustrates a conventional control handle for a game machine, the control handle includes a casing 1. The casing 1 includes a circuit board 12, a direction input portion 14, an operation input portion 16, two movable rockers 18 and two holding portion 19. The circuit board 12 is installed in the casing 1 and is coupled to each of the input portions 14, 16. The direction input portion 14 and the operation input portion 16 are both disposed on a surface of the casing 1 adjacent to two lateral sides thereof, respectively. The two movable rockers 18 protrude from the casing 1 between the direction input portion 14 and the operation input portion 16, and is pivotable by push of the user. The two holding portions 19 are formed at a side of the casing 1 adjacent to the two lateral sides thereof, respectively, for the user to hold.

A drawback in using the conventional control handle of the game machine is that: when the user holds the two holding portions 19 with hands, if it is desired to operate by using the two movable rockers 18, the user needs to move the thumbs onto the two movable rockers 18 to adapt to positions of the movable rockers 18 to conduct the operation; but the surface of the casing 1 and the two holding portions 19 are spaced by a certain distance, and the two movable rockers 18 protrude from the surface of the casing 1, as a result, when the user stretches the thumbs to the direction input portion 14, the operation input portion 16 or the two rockers 18, the user's hands will be kept in a uncomfortable state. As such, after operation of a long time, problems such as hand injury or hand fatigue may occur due to incorrect posture or overexertion of the user's finger tips and hands. Therefore, how to design a control handle that is more ergonomic and allows for comfortability even after long periods of use is an important subject the manufacturers need to address.

### SUMMARY OF THE INVENTION

An object of the present invention is to provide a control apparatus that will not cause injury, fatigue or ache to the hands of users after use. The control apparatus comprises a casing, a circuit board, an operation input portion, a direction input portion and a sensing input portion. The casing on a side thereof comprises two holding portions extending outwardly and toward a bottom of the casing, wherein when viewed by a user that holds the two holding portions, a front of the casing is inclined progressively from a lateral edge of the front away from the user through the bottom of the casing to a lateral edge of the front near the user. The direction input portion is disposed on the front of the casing near one of the holding portions, and the operation input portion is disposed on the front of the casing near the other of the holding portions. The sensing input portion is disposed on the front of the casing between the direction input portion and the operation input portion and near the user. The circuit board is installed in the casing and connected to each input portion. As such, by the provision of the inclination angle of the front of the casing, the user can easily stretch the thumbs of both hands to each input portion for input operation.

### BRIEF DESCRIPTION OF THE DRAWINGS

FIG. 1 is a schematic view of a conventional control apparatus;

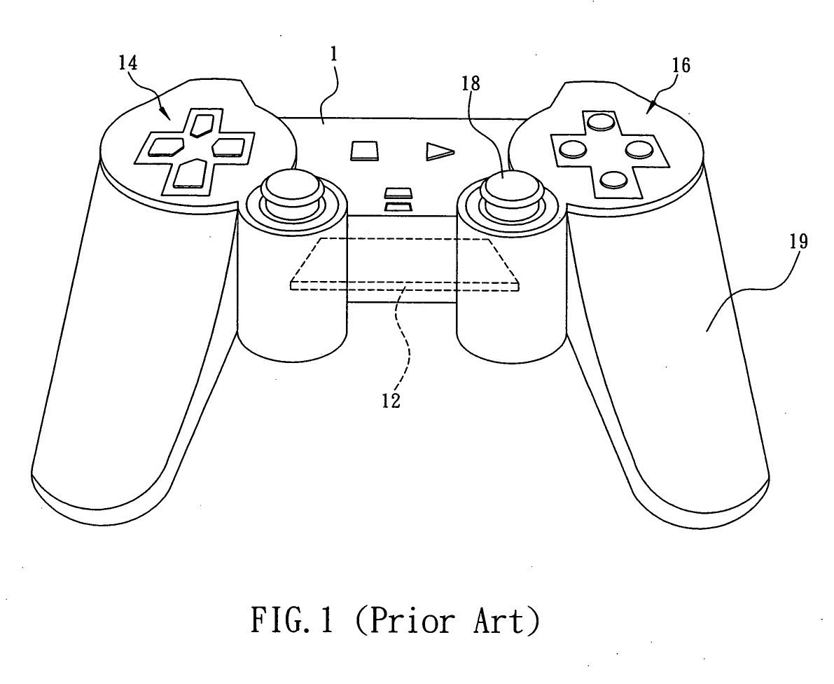

FIG. 2 is a schematic view of a control apparatus in accordance with the present invention;

FIG. 3 is a circuit diagram of the control apparatus in accordance with the present invention; and

FIG. 4 is a side view of the control apparatus in accordance with the present invention.

### DETAILED DESCRIPTION OF THE PREFERRED EMBODIMENTS

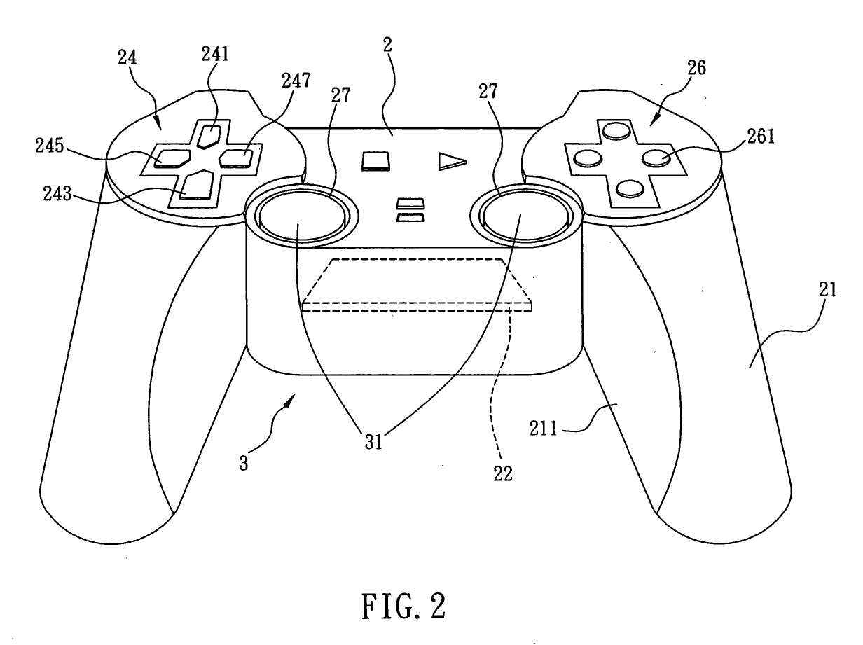

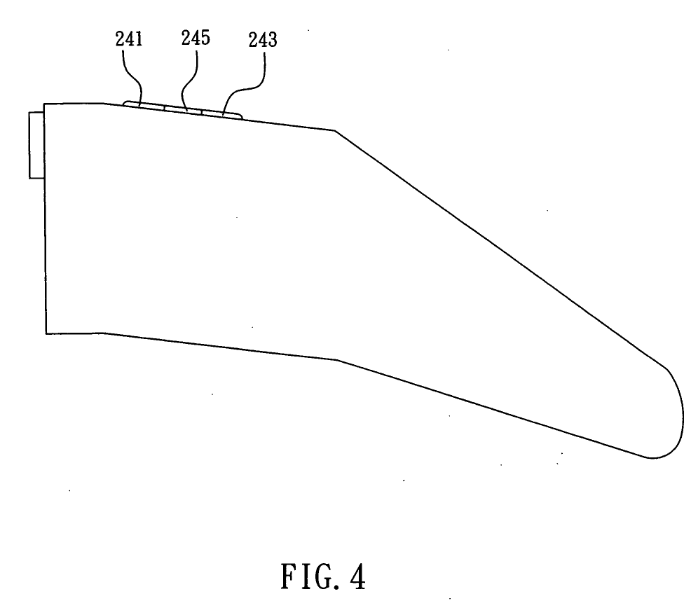

Referring to FIGS. 2 through 4, the present invention discloses a control apparatus. The control apparatus includes a casing 2. The casing 2 has two sides thereof each having a holding portion 21 extending outwardly and toward a bottom of the casing 2 for being held by a user. Due to the aforementioned structure, when the user holds the holding portions 21, a front of the casing 2 is viewed by the user. The front of the casing 2 is inclined progressively from a lateral edge away from the user through the bottom of the casing 2 to an opposite lateral edge near the user. The holding portions 21 are respectively located on two lateral sides of the front of the casing 2 near the user. A circuit board 22 is installed in the casing 2. The casing 2 on the front thereof includes a direction input portion 24, an operation input portion 26 and a sensing input portion 3. The direction input portion 24 is disposed on the front of the casing 2 near one of the holding portions 21, and the operation input portion 26 is disposed on the front of the casing 2 near the other holding portions 21. The sensing input portion 3 is disposed on the front of the casing 2 between the direction input portion 24 and the operation input portion 26. Each of the input portions 24, 26, 3 is connected to the circuit board 22. As such, the user can press or push any of the input portions 24, 26, 3 easily for an input while holding the two holding portions 21 by hands, thus effectively avoiding injury or fatigue to hands.

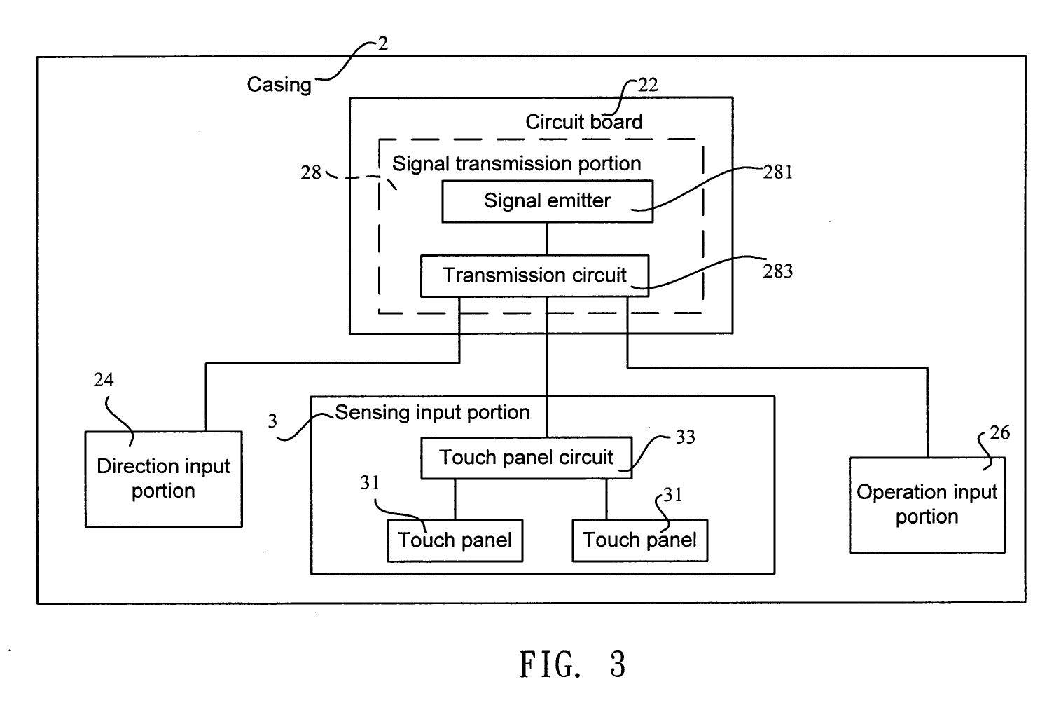

Referring to FIG. 2, in an embodiment of the present invention, the casing 2 has two recesses 27 defined between the direction input portion 24 and the operation input portion 26. The sensing input portion 3 includes two touch panels 31 and a touch panel circuit 33 (see FIG. 3). The touch panels 31 are disposed in the recesses 27, respectively, allowing the user to push and slide on the touch panels 31 for the inputting by fingers. The touch panel circuit 33 is installed in the casing 2, and is coupled to both the touch panels 31 and the circuit board 22 to generate different touch input signals according to the states of the touch panels 31 being touched. The touch input signals are then transmitted to the circuit board 22, thereby achieving the control according to the touch input signals.

Referring again to FIG. 2, in this embodiment, the holding portions 21 each form a recessed arc section 211 thereon. The recessed arc section 211 is recessed inward with respect to the casing 2 and is arc-shaped. While holding the holding portions 21 by hands, the recessed arc section 211 can fit with a raised portion at the base of the thumb of users' palm, thus allowing the users' hands to more closely contact the holding portions 21, and to come closer to each of the input portions 24, 26, 3 during control operation.

Referring again to FIGS. 2 and 3, in this embodiment, the direction input portion 24 at least includes an up direction control key 241, a down direction control key 243, a left direction control key 245 and a right direction control key 247, which are sequentially arranged on the front of the casing 2 along an up-down-left-right direction, and are all coupled to the circuit board 22. In addition, while being operated, the direction control keys 241, 243, 245, 247 generate different direction control signals according to their respective locations on the operation input portion 26, and output the control signals to the circuit board 22, thereby achieving direction control during the control operation by the user.

Referring again to FIGS. 2 and 3, in this embodiment, the operation input portion 26 includes a plurality of operation keys 261 that are arranged on the front of the casing 2 in a specific sequence and are coupled to the circuit board 22. In addition, while being pressed by the user, the operation keys 261 generate different operation signals, and each operation signal is outputted to the circuit board 22 in the order that the operation keys 261 are pressed, thereby achieving the operation control in playing game. The operation keys 261 can be arranged side by side in a row, or alternatively be arranged along an up-down-left-right direction, or in some other sequences.

Referring again to FIGS. 2 and 3, in this embodiment, the casing 2 includes a signal transmission portion 28 on the circuit board 22 for connecting with an electronic device (not shown) that is located outside of the casing 2. The signal transmission portion 28 is coupled to each of the input portions 24, 26, 3, for receiving the various direction control signals, touch input signals, and operation signals generated by the input portions 24, 26, 3, respectively, and transmitting the received signals to the electronic device that is located outside of the casing 2.

Referring again to FIGS. 2 and 3, in this embodiment, the signal transmission portion 28 includes a signal emitter 281 and a transmission circuit 283. The transmission circuit 283 is coupled to each of the circuit board 22 and the signal emitter 281, for receiving the various direction control signals, touch input signals, and operation signals, and transmitting the received signals to signal emitter 281 so that the signals are transmitted to the electronic device (not shown).

Referring again to FIGS. 2 through 4, in this embodiment, the signal emitter 281 is an infrared emitter allowing the user to operate with greater convenience. The signal emitter 281 is coupled to the transmission circuit 283, and receives the direction control signals, touch input signals, and operation signals from the transmission circuit 283. In addition, an angle formed between the front and the bottom of the casing 2 is between 30 to 50 degrees, allowing the users' hand to more easily stretch to the input portions 24, 26, 3 for operation inputs.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A control apparatus comprising:
a casing with two sides each comprising a holding portion extending outwardly and towards a bottom of the casing for being held by a user while viewing a front of the casing, the front of the casing is inclined progressively from a lateral edge of the front away from the user through the bottom of the casing to an opposite lateral edge of the front near the user;
a direction input portion disposed on the front of the casing near one of the holding portions;
an operation input portion disposed on the front of the casing near the other holding portion;
a sensing input portion disposed on the front of the casing between the direction input portion and the operation input portion and proximate to the user; and
a circuit board installed in the casing and connected to each of the direction input portion, the operation input portion and the sensing input portion.

2. The control apparatus in accordance with claim 1, wherein the casing comprises:
two recesses defined between the direction input portion and the operation input portion;
and the sensing input portion comprises:
two touch panels disposed in the two recesses, respectively; and
a touch panel circuit disposed in the casing and coupled to each of the touch panels and the circuit board, the touch panel circuit configured to generate different touch input signals according to states of the touch panels being touched, and transmit the touch input signals to the circuit board.

3. The control apparatus in accordance with claim 1, wherein the holding portions each comprise a recessed arc section thereon for fitting with a raised portion at the base of the thumb of users' palm, the recessed arc section is recessed inward with respect to the casing and is arc-shaped.

4. The control apparatus in accordance with claim 1, wherein the direction input portion comprises four direction control keys that are sequentially arranged on the front of the casing along an up-down-left-right direction, and the direction control keys generate different direction control signals according to their respective locations on the operation input portion while being operated, and transmit the control signals to the circuit board.

5. The control apparatus in accordance with claim 1, wherein the operation input portion comprises a plurality of operation keys, which are arranged on the front of the casing in a specific sequence, the operation keys generate different operation signals when being pressed by the user, and transmit the operation signals to the circuit board.

6. The control apparatus in accordance with claim 5, wherein the circuit board comprises a signal transmission portion coupled to each of the input portions for receiving the direction control signals, touch input signals, and operation signals generated by the input portions, respectively.

7. The control apparatus in accordance with claim 6, wherein the signal transmission portion comprises:
a transmission circuit configured to receive the direction control signals, touch input signals, and operation signals; and
a signal emitter coupled to the transmission circuit and configured to receive the direction control signals, touch input signals, and operation signals from the transmission circuit.

8. The control apparatus in accordance with claim 7, wherein the signal emitter is an infrared emitter.

9. The control apparatus in accordance with claim 7, wherein an angle formed between the front and the bottom of the casing is between 30 to 50 degrees.
